(19) United States
(12) Patent Application Publication
(10) Pub. No.: US 2004/0227706 A1
(43) Pub. Date: Nov. 18, 2004

(54) Driving method for active matrix oled display

(76) Inventor: Chao-Chin Sung, Pingtung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/791,158

(22) Filed: Mar. 1, 2004

(30) Foreign Application Priority Data
May 14, 2003 (TW) 92113027

(51) Int. Cl. G09G 3/30

(52) U.S. Cl. 345/76

(57) ABSTRACT

A driving method for an active matrix OLED display. In the driving method, a first current is provided to flow through an OLED of a pixel in a first period of one display period, according to a video signal on the data electrode and a scan signal on the scan electrode. Next, a second current is provided to flow through the OLED in a second period of the display period to neutralize carrier accumulation inside the OLED, wherein the first current and the second current flow in opposite directions.

### BACKGROUND OF THE INVENTION

1. Field of the Invention

The present invention relates to a driving method, and more particularly, to a driving method for an active matrix OLED display, as well as a pixel structure using the same.

2. Description of the Related Art

Typically, an active matrix OLED display employs a large number of pixels to present an image, and controls the brightness of each pixel according to a brightness data.

FIG. 1 shows a pixel structure 10 of an active matrix organic light emitting diode (AMOLED). The switching transistor T₁ is turned on and a data voltage indicated brightness is applied to a data electrode DATA when the scan electrode SCAN is activated. Thus, the storage capacitor Cₛ is charged or discharged, and the potential at the gate of the driving transistor T₂ may coincide with that of the data voltage. The switching transistor T₁ is turned off and the driving transistor T₂ is electrically isolated from the data electrode DATA when the scan electrode SCAN is not activated. The data voltage is stored in the storage capacitor Cₛ, and the potential at the gate of the driving transistor T₂ is maintained. The produced driving current I flows to the OLED 20 through the driving transistor T₂ according to the voltage (Vgs) between the gate and source of the driving transistor T₂. The OLED 20 then continuously illuminates according to the driving current I.

That is, in one display frame, the current received by the OLED is fixed. However, this driving method accumulates carriers inside the OLED 20 which reduce the life of the OLEDs. Moreover, the voltage Vₒ across the OLED gradually increases over time as shown in FIG. 3. Further, as shown by the formula P=I×V, as the voltage Vₒ increases over time, the power P also increases. In FIG. 3, curve C₁ shows the effect of the voltage Vₒ of the OLED over time.

### SUMMARY OF THE INVENTION

It is therefore an object of the present invention to neutralize carrier accumulation in the OLED of an LCD, thereby reducing the increase in voltage and minimizing the increase in power consumption across both ends of the OLED over time, further increasing the life of the OLED.

According to the above mentioned objects, the present invention provides a driving method for an active matrix OLED display. The driving method provides a first current to flow through an OLED of a pixel in a first period of one display period, according to a video signal on the data electrode and a scan signal on the scan electrode. Next, a second current is provided to flow through the OLED in a second period of the display period to neutralize carrier accumulation inside the OLED. Wherein the first current and the second current flow in opposite directions.

According to the above mentioned objects, the present invention provides a pixel structure of an active matrix OLED display, which is capable of neutralizing carrier accumulation in an OLED. In the pixel structure of the present invention, a switching transistor has a control terminal coupled to a scan electrode and a first terminal coupled to a data electrode. A driving transistor has a control terminal coupled to a second electrode of the switching transistor and a first terminal coupled to a power voltage. An OLED has an anode coupled to the second terminal of the driving transistor, and a cathode coupled to a common electrode. A storage capacitor has one terminal coupled to the control terminal of the driving transistor. A neutralization control circuit is coupled between the OLED and a first voltage, according to a control signal, to pull down the potential at the anode of the OLED thereby inducing a reverse current to neutralize the carrier accumulation in the OLED. The potential of the first voltage is lower than that at the cathode of the OLED.

### BRIEF DESCRIPTION OF THE DRAWINGS

The present invention can be more fully understood by reading the subsequent detailed description and examples with reference made to the accompanying drawings, wherein:

FIG. 1 shows a pixel structure of a conventional active matrix OLED display;

FIG. 2 is a schematic diagram illustrating a conventional driving method for active matrix OLED display;

FIG. 3 shows the relationship between the voltage across both ends of the OLED and its life in the conventional pixel structure;

FIG. 4 is a diagram illustrating a driving method of the present invention;

FIG. 5 shows the pixel structure of an active matrix OLED display according to the present invention;

FIG. 6 is another diagram illustrating the driving method of the present invention;

FIG. 7 shows the relationship between the voltage across both ends of the OLED and its life using the conventional driving method and that of the present invention; and

FIG. 8 shows the relationship between the brightness and OLED life according to the present invention.

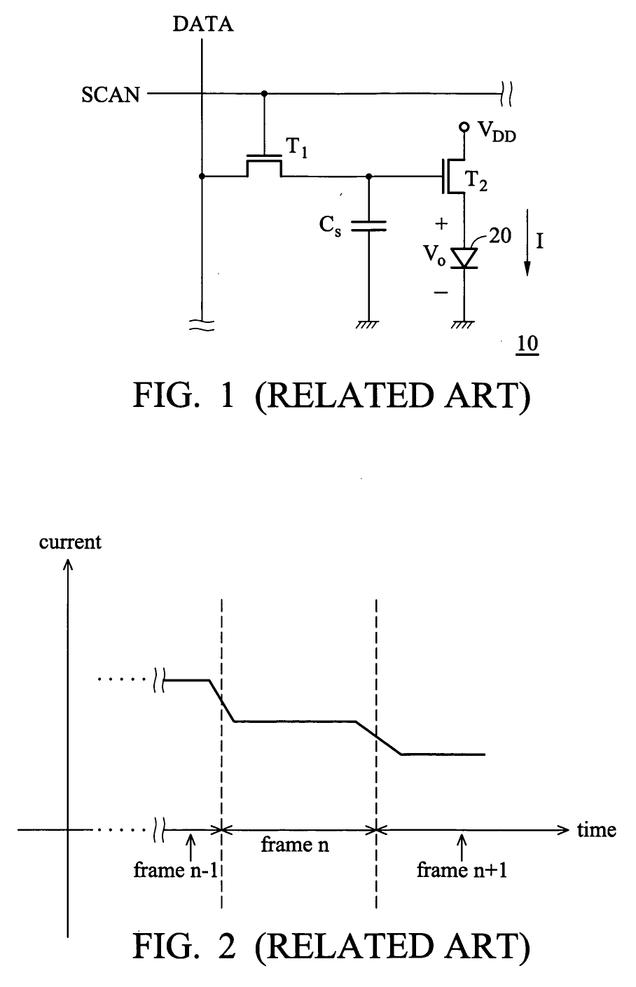

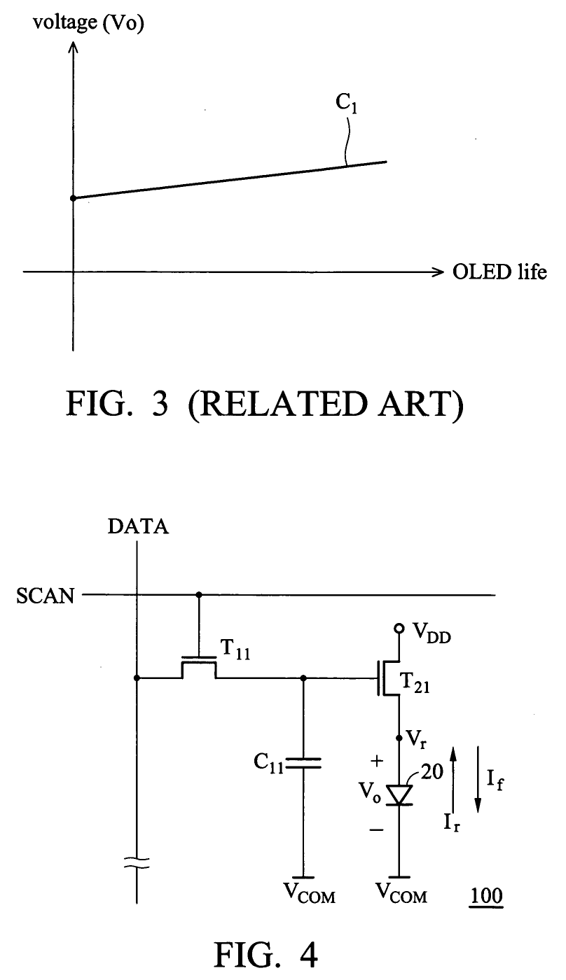

### DETAILED DESCRIPTION OF THE INVENTION

FIG. 4 shows a pixel structure 100 of an active matrix OLED display. In the pixel structure 100, the switching transistor T₁₁ has a control terminal coupled to a scan electrode SCAN, and a first terminal coupled to a data electrode DATA. A driving transistor T₂₁ has a control terminal coupled to a second terminal of the switching transistor T₁₁, and a first terminal coupled to a power voltage V_{DD}. An OLED 20 has an anode coupled to the second terminal of the driving transistor T₂₁, and a cathode coupled to a common electrode (not shown), wherein the common electrode has a potential of V_{COM}. A storage capacitor C₁₁ has one terminal coupled to the control terminal of the driving transistor T₂₁.

The driving method of the present invention is described below with reference to FIG. 4 and FIG. 6. First, in a first period T_{f} of one display frame N, a first current is provided and flows through the OLED 20 according to a data signal on the electrode DATA and a scan signal on the scan electrode SCAN. That is, the switching transistor T₁₁ is turned on and the storage capacitor C₁₁ is charged or discharged by the data signal on the data electrode DATA according to the scan signal on the scan electrode SCAN. At this time, the gate voltage of the driving transistor T₂₁ can be adjusted and stored in the storage capacitor C₁₁. The driving transistor T₂₁ provides the first current I_{f} to flow through the OLED 20 according to the gate voltage of the transistor T₂₁, and the OLED illuminates accordingly. The switching transistor T₁₁ is then turned off, but driving transistor T₂₁ is still turned on according to the voltage stored in the storage capacitor C₁₁, and the OLED 20 illuminates with the same brightness. Because of the above mentioned step, carrier accumulation in the OLED 20, and further, the voltage across both ends of the OLED 20 increases as over time. Thus, the effective life of the OLED 20 may be reduced.

In view of this, the present invention provides a step of providing a second current Iᵣ opposite to the first current I_{f} to flow through the OLED in a second period Tᵣ of the display frame N. For example, the current I_{f} flows from anode to cathode and the current Iᵣ flows from cathode to anode, and vice versa. In the present invention neutralizes carrier accumulation in the OLED 20 by the second current Iᵣ. The time ratio of the first period T_{f} to the second period Tᵣ can be between 1:1˜10⁵:1, for example 10:1.

In this embodiment, the second current Iᵣ is obtained by pulling up the potential V_{COM} at the cathode of the OLED higher than the power voltage V_{DD}. As the potential V_{COM} at the cathode of the OLED 20 is higher than the power voltage V_{DD}, the potential V_{COM} is higher than the voltage Vᵣ at the anode of the OLED 20. Thus, the voltage Vₒ across the OLED 20 becomes negative, and the second current Iᵣ opposite to the first current I_{f} is produced to neutralize the carrier accumulation in the OLED 20. In addition, the second current Iᵣ opposite to the first current I_{f} can also be obtained by providing a negative voltage across the anode and cathode of the OLED. Alternately, the second current Iᵣ can be provided to flow through the OLED 20 before each first period T_{f} (first current I_{f}) of the display frame N.

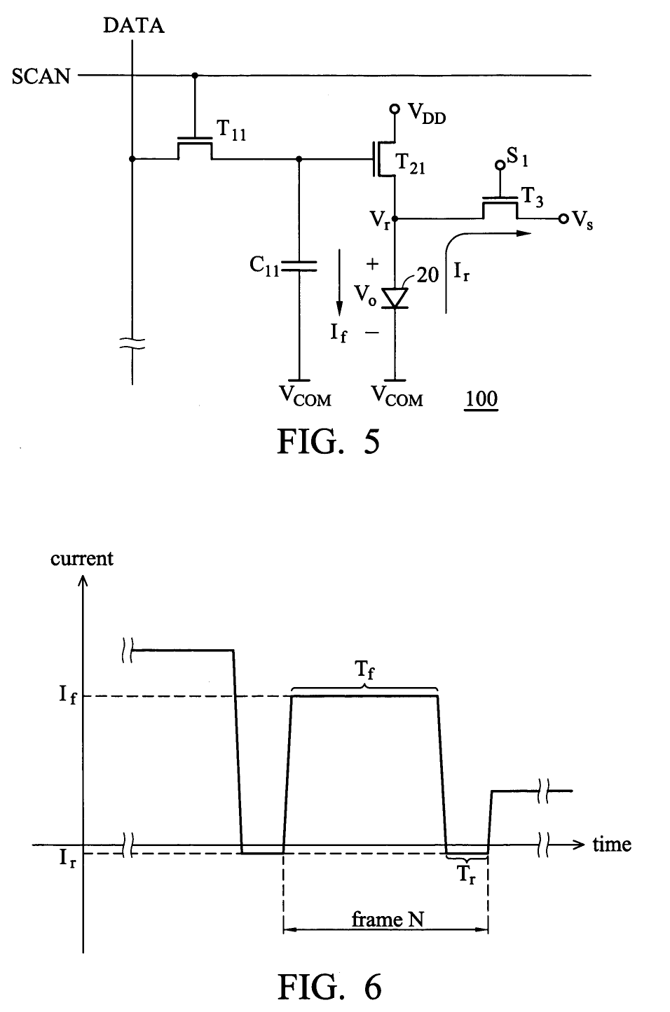

Additionally, the present invention provides a pixel structure capable of neutralizing carrier accumulation in OLED, as shown in FIG. 5. In FIG. 5, a switching transistor T₁₁ has a control terminal coupled to a scan electrode SCAN and a first terminal coupled to a data electrode DATA. A driving transistor T₂₁ has a control terminal coupled to a second electrode of the switching transistor T₁₁ and a first terminal coupled to a power voltage V_{DD}. The OLED 20 has an anode coupled to the second terminal of the driving transistor T₂₁, and a cathode coupled to a common electrode (not shown) A storage capacitor C₁₁ has one terminal coupled to the control terminal of the driving transistor T₂₁.

The present invention utilizes a transistor T₃ as a neutralization control circuit coupled between the OLED and a first voltage Vₛ, wherein the potential of the first voltage Vₛ is lower than the potential V_{COM} at the cathode of the OLED 20. In the second period Tᵣ of the display frame N, the transistor T₃ pulls the potential Vᵣ at the anode of the OLED 20 lower than the potential V_{COM}, according to a control signal S₁. At this time, the voltage Vₒ across the OLED 20 becomes negative, and thus a reverse current Iᵣ opposite to the current I_{f} is induced to neutralize carrier accumulation in the OLED 20. For example, the current I_{f} flows from anode to cathode and the current Iᵣ flows from cathode to anode, and vice versa. The time ratio of the first period T_{f} (current I_{f}) between and the second period Tᵣ (current Iᵣ) can be 1:1˜10⁵:1, for example 10:1. The embodiment of the present invention for producing a reverse current to flow through an OLED is provided as an example, and is not intended to constrain the application of this invention.

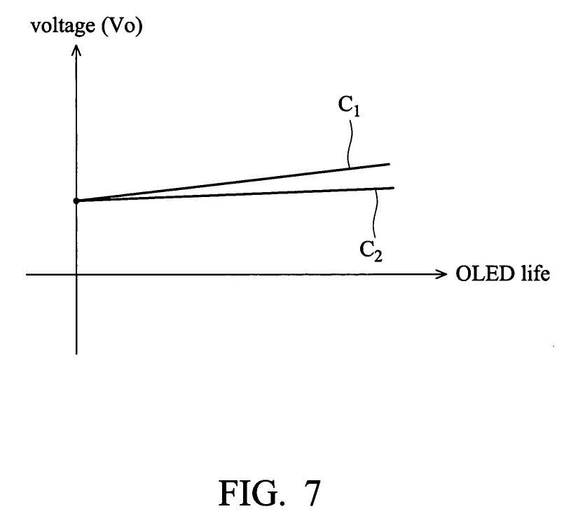

FIG. 7 shows the relationship between the voltage Vₒ across both ends of the OLED 20 and its life using the conventional driving method and the method of the present invention. Curve C₁ shows the relationship between the voltage Vₒ across both ends of the OLED 20 and its life in the present invention. Curve C₂ show the relationship between the voltage Vₒ across both ends of the OLED and its life using the conventional driving method. Obviously, the present invention can reduce increased voltage across both ends of the OLED over time. Additionally, the present invention can also reduce increased power consumption of to OLED over time, as shown by the formula P=I×V.

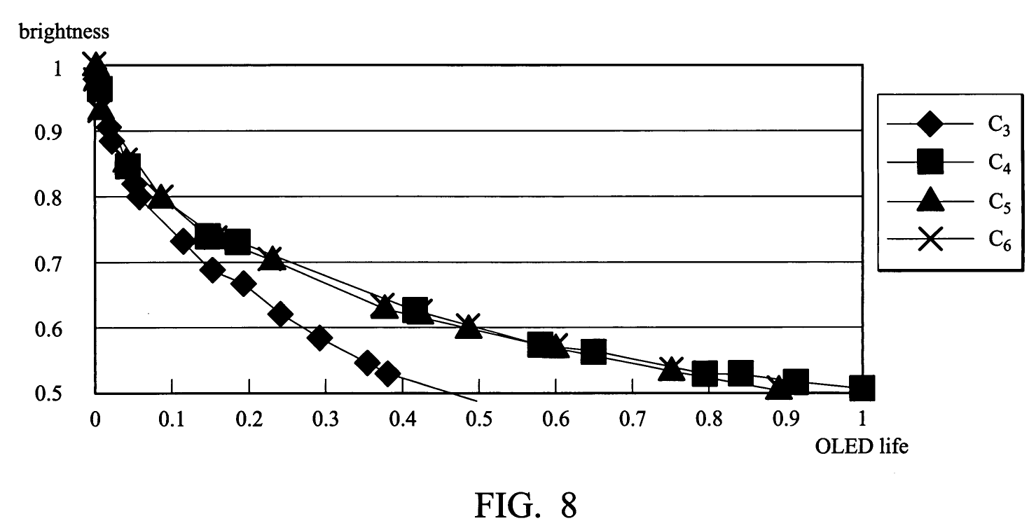

FIG. 8 shows the relationship between the brightness and the life of an OLED according to the present invention. In FIG. 8, curve C₃ shows the relationship between the brightness and the life of an OLED without using a reverse current to neutralize carrier accumulation in the OLED. Curve C₄ shows the relationship between the brightness and the life of an OLED with a reverse current Iᵣ to neutralize carrier accumulation in the OLED, wherein the time ratio of the first period T_{f} (current I_{f}) to the second period Tᵣ (current Iᵣ) is 10:1. Curve C5 shows the relationship between the brightness and the life of an OLED using the reverse current, wherein the time ratio of the first period T_{f} (current I_{f}) to the second period Tᵣ (current Iᵣ) is 100:1. Curve C₅ shows the relationship between the brightness and the life of an OLED with the reverse current, wherein time ratio of the first period T_{f} (current I_{f}) to the second period Tᵣ (current Iᵣ) is 500:1. As shown in FIG. 8, the life of OLED using a reverse current to neutralize carrier accumulation therein is about double of the conventional OLED and driving method not employing reverse current. Therefore, the present invention reduces the increase in voltage and minimizes the increase in power consumption across both ends of the OLED over time, further increasing the life of the OLED.

Furthermore, in the present invention, a period for producing a reverse current to neutralize carrier accumulation in the OLED is not limited to one display frame but extend to two or more display frames. For example, the first, fourth and seventh display frames each have a period for producing a reverse current to neutralize carrier accumulation in the OLED. The second, third, fifth and sixth display frames have no period for producing a reverse current to neutralize carrier accumulation in an OLED.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving method for an active matrix OLED display, wherein the display has at least one pixel, each having a switch transistor, a driving transistor, an OLED and a storage capacitor, the switching transistor has a control terminal coupled to a scan electrode and a first terminal coupled to a data electrode, the driving transistor has a control terminal coupled to a second terminal of the switching transistor and a first terminal coupled to a power voltage, the OLED has an anode couple to the second terminal of the driving transistor and a cathode coupled to a common electrode, and the storage capacitor has one terminal coupled to the control terminal of the driving transistor, the driving method comprising:
providing a first current to flow through the OLED of the pixel in a first period of one display period, according to a video signal on the data electrode and a scan signal on the scan electrode; and
providing a second current to flow through the OLED in a second period of the display period to neutralize carrier accumulation inside the OLED, wherein the first current and the second current flow in opposite directions.

2. The driving method as claimed in claim 1, wherein the second current is produced by pulling the potential at the anode of the OLED to lower than that at the cathode of the OLED.

3. The driving method as claimed in claim 1, wherein the second current is produced by pulling the potential at the cathode of the OLED to higher than that at the anode of the OLED.

4. The driving method as claimed in claim 1, wherein the second current is produced by applying a negative voltage across the anode and the cathode of the OLED.

5. The driving method as claimed in claim 1, wherein the time ratio of the first period to the second period is between 1:1˜10⁵:1.

6. The driving method as claimed in claim 1, wherein the time ratio of the first period to the second period is 10:1.

7. A driving method for an active matrix OLED display, wherein the display has at least one pixel each having a switch transistor, a driving transistor, an OLED and a storage capacitor, the switching transistor has a control terminal coupled to a scan electrode and a first terminal coupled to a data electrode, the driving transistor has a control terminal coupled to a second terminal of the switching transistor and a first terminal coupled to a power voltage, the OLED has an anode coupled to the second terminal of the driving transistor and a cathode coupled to a common electrode, and the storage capacitor has one terminal coupled to the control terminal of the driving transistor, the driving method comprising:
providing a first current to flow through the OLED of the pixel in a first period of a first display period, according to a first video signal on the data electrode and a first scan signal on the scan electrode;
providing a reverse current to flow through the OLED in a second period of the first display period to neutralize carrier accumulation inside the OLED, wherein the first current and the reverse current flow in opposite directions;
providing a second current to the OLED of the pixel in a second display period, according to a second video signal on the data electrode and a second scan signal on the scan electrode;
providing a third current to the OLED of the pixel in a first period of a third display period, according to a third video signal on the data electrode and a third scan signal on the scan electrode; and
providing the reverse current to the OLED in a second period of the third display period to neutralize carrier accumulation inside the OLED, wherein the third current and the reverse current flow in opposite directions.

8. The driving method as claimed in claim 1, wherein the second current is produced by pulling the potential at the anode of the OLED to lower than that at the cathode of the OLED.

9. The driving method as claimed in claim 1, wherein the second current is produced by pulling the potential at the cathode of the OLED to higher than that at the anode of the OLED.

10. The driving method as claimed in claim 1, wherein the second current is produced by applying a negative voltage across the anode and the cathode of the OLED.

11. The driving method as claimed in claim 1, wherein the time ratio of the first period to the second period is in a range between 1:1˜10⁵:1.

12. The driving method as claimed in claim 1, wherein the time ratio of the first periods to the second periods is 10:1.

13. A driving method for active matrix OLED display, wherein the display includes at least one pixel, a data electrode, a scan electrode and a common electrode, the pixel has an OLED, the driving method comprising:
providing a first current to flow through the OLED of the pixel in a display period, according to a first video signal on the data electrode and a first scan signal on the scan electrode; and
providing a reverse current to flow through the OLED of the pixel before the next display period to neutralize carrier accumulation inside the OLED, wherein the first current and the reverse current flow in opposite directions.

14. The driving method as claimed in claim 13, wherein the OLED has an anode and a cathode, and the second current is produced by pulling the potential at the cathode of the OLED to higher than that at the anode of the OLED.

15. The driving method as claimed in claim 13, wherein the OLED has an anode and a cathode, and the second current is produced by pulling the potential at the anode of the OLED to lower than that at the cathode of the OLED.

16. The driving method as claimed in claim 13, wherein the OLED has an anode and a cathode, the second current is produced by applying a negative voltage across the anode and the cathode of the OLED.

17. A pixel structure for active matrix OLED display, comprising:
a switching transistor having a control terminal coupled to a scan electrode and a first terminal coupled to a data electrode;
a driving transistor having a control terminal coupled to a second electrode of the switching transistor and a first terminal coupled to a power voltage;
a OLED having an anode coupled to the second terminal of the driving transistor, and a cathode coupled to a common electrode;
a storage capacitor having one terminal coupled to the control terminal of the driving transistor; and
a neutralization control circuit coupled between the OLED and a first voltage, according to a control signal, to pull down the potential at the anode of the OLED thereby inducing a reverse current to neutralize carrier accumulation inside the OLED, wherein the potential of the first voltage is lower than that at the cathode of OLED.

18. The pixel structure as claimed in claim 17, wherein the neutralization control circuit is a transistor having a control terminal coupled to the control signal, a first terminal coupled to the anode of the OLED and a second terminal coupled to the first voltage.
